(19) United States
(12) Patent Application Publication
(10) Pub. No.: US 2004/0155568 A1
(43) Pub. Date: Aug. 12, 2004

(54) Mask assembly and cathode ray tube

(76) Inventors: Yusuke Akiyama, Tokyo (JP); Haruo Watanuki, Tokyo (JP); Keizou Makino, Tokyo (JP); Toshikazu Karita, Tokyo (JP); Masahiro Nakazawa, Tokyo (JP)

Correspondence Address: BIRCH STEWART KOLASCH & BIRCH, PO BOX 747, FALLS CHURCH, VA, 22040-0747, US

(21) Appl. No.: 10/730,082

(22) Filed: Dec. 9, 2003

(30) Foreign Application Priority Data
Jan. 21, 2003 (JP) 2003-011974

(51) Int. Cl. H01J 29/80

(52) U.S. Cl. 313/402

(57) ABSTRACT

A color selection mask is provided with an aperture region including a slit region (21) and bridge regions (22). The bridge regions (22) are provided on top and bottom ends of the aperture region. In the slit region (21), slits (123) through which electron beams pass and strips (124) are arranged alternately. The strips (124) extend into the bridge regions (22), where bridges (25) for connecting adjacent two of the strips (124) and through holes (122) through which electron beams pass are provided.

### BACKGROUND OF THE INVENTION

1. Field of the Invention

The present invention relates to a mask assembly mounted in a cathode ray tube.

2. Description of the Background Art

A mask assembly for performing color selection is mounted in a color cathode ray tube used for television sets, computer displays, etc.

Such mask assembly generally includes a color selection mask formed of a metal sheet perforated with a great number of holes through which electron beams pass by selective etching and a mask frame for supporting the color selection mask. An exemplary color selection mask is a slot-type mask. The slot-type mask has substantially rectangular holes (slots), through which electron beams pass.

Another example is a color selection mask having a great number of strips (also called “grille elements”) aligned with predetermined intervals and slits each of which lies between two adjacent strips, through which electron beams pass. Such mask is called an “aperture grille”.

One of advantages of the aperture grille as compared to the slot-type mask resides in heat resistance. The aperture grille is supported by a mask frame and receives tension in the longitudinal direction of strips. This can control the occurrence of doming effect due to thermal expansion of the color selection mask, which allows color discrepancies on the screen of a cathode ray tube to be reduced.

An impact applied from outside a cathode ray tube and vibrations of a speaker and the like are transmitted to a tension-type color selection mask supported by a mask frame under tension, represented by the aperture grille, through the mask frame, preventing vibrations from being sufficiently controlled with a supporting tension, which may cause the color selection mask to be vibrated. Such vibrations of the color selection mask can significantly be seen as flickering images, which is not a preferable phenomenon.

Therefore, there have been a variety of ideas for controlling vibrations of the color selection mask. For instance, techniques of controlling vibrations of a color selection mask are disclosed in, e.g., Japanese Patent Application Laid-Open Nos. 5-266819 (1992) (Document 1), 11-224615 (1998) (Document 2) and 11-250825 (1998) (Document 3).

In the case where a mask frame and strips have the same natural frequency in a mask assembly employing a tension-type color selection mask having strips such as an aperture grille, the mask frame and strips resonate with each other when vibrations are applied from outside, which may cause vibrations of the color selection mask to be increased.

Since the natural frequency of strips depend on tension applied thereto, adjusting tension applied to the color selection mask allows the mask frame and strips to have different natural frequencies. However, reduction in tension applied to the color selection mask causes the color selection mask to be easily vibrated in response to vibrations applied from outside. On the other hand, increase in tension requires the mask frame to be increased in rigidity. Therefore, it is difficult to control vibrations of the color selection mask by adjusting tension applied to the color selection mask.

### SUMMARY OF THE INVENTION

An object of the present invention is to provide a technique capable of controlling vibrations of a tension-type color selection mask having strips without adjusting tension applied thereto.

The present invention is directed to a mask assembly including a color selection mask and a mask frame. The color selection mask includes an aperture region provided with a plurality of holes through which electron beams pass. The mask frame supports the color selection mask and applies tension to the color selection mask in a first direction. The aperture region has a bridge region at an end thereof in the first direction and a slit region adjacent to the bridge region at least in the first direction. The slit region has a plurality of strips, each extending in the first direction, arranged at a predetermined pitch in a second direction perpendicular to the first direction and a plurality of slits, each being defined between adjacent two of the plurality of strips. The bridge region, into which the plurality of strips extend, has bridges for connecting adjacent two of the plurality of strips.

Adjusting the ratio between areas that the slit region and bridge region occupy in the aperture region allows the mask frame and strips to have different natural frequencies. Therefore, vibrations of the strips in the slit region can be controlled without adjusting tension applied to the color selection mask.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view illustrating the structure of a color cathode ray tube according to a first preferred embodiment of the present invention;

FIG. 2 is a perspective view illustrating the structure of a mask assembly according to the first preferred embodiment;

FIGS. 3 and 4 are plan views illustrating the structure of a color selection mask according to the first preferred embodiment;

FIGS. 5 and 6 are plan views illustrating the structure of a color selection mask according to a variant of the first preferred embodiment;

FIG. 7 is a plan view illustrating the structure of a color selection mask according to another variant of the first preferred embodiment;

FIG. 8 is a plan view illustrating the structure of a color selection mask according to a second preferred embodiment of the invention;

FIGS. 9 and 10 are plan views illustrating the structure of a color selection mask according to a variant of the second preferred embodiment;

FIGS. 11 and 12 are plan views illustrating the structure of a color selection mask according to another variant of the second preferred embodiment;

FIG. 13 is a plan view illustrating the structure of a color selection mask according to still another variant of the second preferred embodiment;

FIGS. 14A and 14B illustrate the manner in which strips come into contact with each other;

FIGS. 15A and 15B illustrate the configuration of strips according to a third preferred embodiment of the invention; and

FIGS. 16A and 16B illustrate the configuration of strips according to a variant of the third preferred embodiment.

### DESCRIPTION OF THE PREFERRED EMBODIMENTS

### First Preferred Embodiment

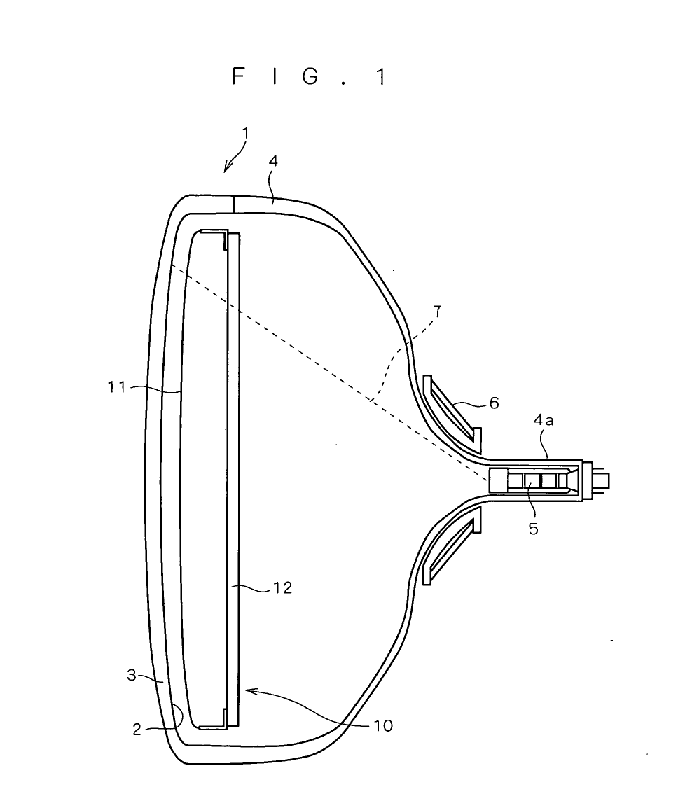

FIG. 1 is a sectional view illustrating the structure of a color cathode ray tube 1 according to a first preferred embodiment of the present invention. As shown in FIG. 1, the color cathode ray tube 1 according to the present embodiment includes a face panel 3 having a phosphor screen 2 formed on its inner surface and a funnel 4 connected to the face panel 3.

The funnel 4 has a neck 4a, where an electron gun 5 is mounted. Inside the face panel 3, a mask assembly 10 including a color selection mask 11 and a mask frame 12 for supporting the color selection mask 11 are mounted. Outside the funnel 4, a deflection yoke 6 for deflecting electron beams emitted from the electron gun 5 to cause them to scan.

The mask assembly 10 is mounted such that the color selection mask 11 faces the phosphor screen 2. Three electron beams 7 emitted from the electron gun 5 are subjected to color selection by the color selection mask 11 so as to land at red-emissive, blue-emissive and green-emissive phosphors on the phosphor screen 2, respectively.

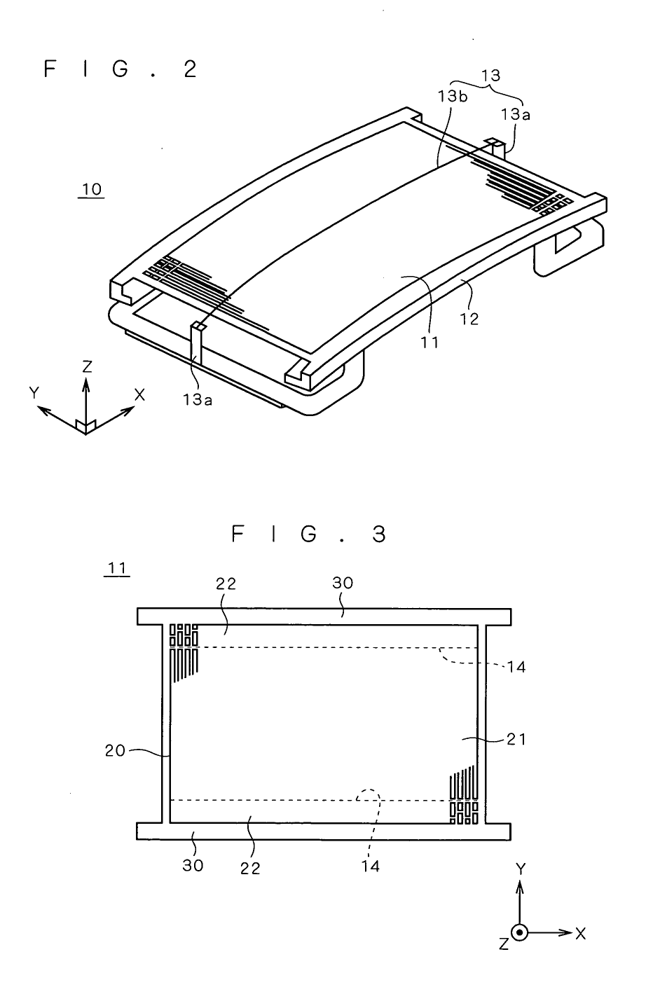

Next, the mask assembly 10 according to the present embodiment will be described in detail. FIG. 2 is a perspective view illustrating the structure of the mask assembly 10. The X, Y and Z axes in the drawing indicate the horizontal direction of the screen, the vertical direction of the screen and the axial direction of the cathode ray tube 1 when the mask assembly 10 is mounted in the funnel 4.

As shown in FIG. 2, the mask assembly 10 includes the color selection mask 11, mask frame 12 for supporting the color selection mask 11 under tension and vibration damper 13 provided in contact with the color selection mask 11 for controlling vibrations of the color selection mask 11. The mask frame 12 is bonded to the both ends of the color selection mask 11 along the Y axis and applies tension along the Y axis to the color selection mask 11.

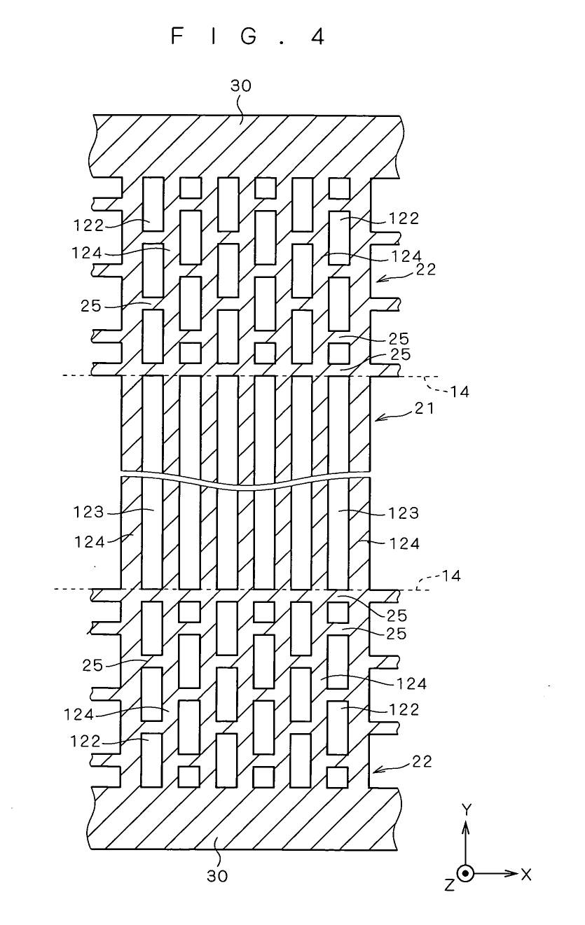

FIGS. 3 and 4 are plan views illustrating the structure of the color selection mask 11. FIG. 3 is a general view and FIG. 4 is a partially enlarged view. As shown in FIG. 3, the color selection mask 11 has bonding regions 30 to be bonded to the mask frame 12 and an aperture region 20 perforated with a plurality of holes through which electron beams emitted from the electron gun 5 pass. The bonding regions 30 are located at the both ends of the color selection mask 11 along the Y axis. The aperture region 20 extends substantially from one end to the other end of the color selection mask 11 along the X axis and is interposed between the bonding regions 30 along the Y axis. The dimensions of the aperture region 20 correspond to those of an active region on the screen of the color cathode ray tube 1 on which images are actually displayed.

The aperture region 20 includes a slit region 21 functioning as an aperture grille and bridge regions 22 functioning as slot-type masks, as shown in FIGS. 3 and 4. The bridge regions 22 are provided at the both ends of the aperture region 20 along the Y axis and each extend from one end to the other end of the aperture region 20 along the X axis. The slit region 21 extends from one end to the other end of the aperture region 20 along the X axis and is interposed between the bridge regions 22 along the Y axis. In other words, the slit region 21 is adjacent to the bridge regions 22 along the Y axis. A schematic border 14 between the slit region 21 and each of the bridge regions 22 extends linearly along the X axis.

As shown in FIG. 4, the slit region 21 has a plurality of strips 124 extending along the Y axis, arranged along the X axis at a predetermined pitch. The slit region 21 also has a plurality of slits 123, each being defined by adjacent two of the strips 124. In the present embodiment, the slits 123 have uniform length along the Y axis, and the ends of the slits 123 along the Y axis are aligned linearly along the X axis. As described, the slit region 21 has the slits 123 and strips 124 provided alternately along the X axis, which therefore functions as an aperture grille in which electron beams pass through the slits 123.

The strips 124 in the slit region 21 extend into the bridge regions 22 to be connected to the bonding regions 30. That is, the strips 124 extends from one of the bonding regions 30 located on the top end of the color selection mask 11 to the other one of the bonding regions 30 located on the bottom end of the color selection mask 11. Hereinafter, those of the strips 124 lying only in the slit region 21 may be called “strips 124a” and those lying only in the bridge regions 22 may be called “strips 124b”.

In the bridge regions 22, bridges (tie bars) 25 for connecting adjacent two of the strips 124 are provided. Adjacent two of the strips 124 are provided with a plurality of bridges 25. A plurality of rectangular through holes 122 are provided, each of which is surrounded by adjacent two of the bridges 25 along the Y axis and adjacent two of the strips 124 or by one of the bonding regions 30, one of the bridges 25 adjacent to the one of the bonding regions 30 along the Y axis and adjacent two of the strips 124.

In the bridge regions 22 of the present embodiment, those of the bridges 25 lying between the slits 123 and those of the through holes 122 lying adjacent to the slits 123 along the Y axis are aligned linearly along the X axis. Therefore, the slits 123 have uniform length along the Y axis, and the ends of the slits 123 along the Y axis are aligned linearly along the X axis. The rest of the bridges 25 are arranged in a staggered manner. Therefore, a large part of the through holes 122 are arranged in a staggered manner.

As described, appropriately providing the bridges 25 for connecting adjacent two of the strips 124 allows the bridge regions 22 to function as a slot-type mask in which electron beams pass through the through holes 122.

The vibration damper 13 has a pair of damper springs 13a attached to the mask frame 12 and a damper line 13b tensioned between the damper springs 13a. The damper line 13b extends along the X axis and is in contact with the strips 124a in the slit region 21. Further, the damper line 13b receives tension along the X axis created by the pair of damper springs 13a.

In this way, providing the damper line 13b to be in contact with the strips 124a in the slit region 21 creates friction between the damper line 13b and strips 124a, which allows vibrations of the color selection mask 11 to be controlled.

As above described, the mask assembly 10 according to the present embodiment is provided with the slit region 21 and bridge regions 22 in the aperture region 20. Therefore, adjusting the ratio between the areas that the slit region 21 and bridge regions 22 occupy in the aperture region 20 allows the natural frequency of the strips 124a in the slit region 21 to be adjusted.

Specifically, increasing the dimension of the bridge regions 22 along the Y axis causes the dimension of the slit region 21 along the Y axis to be decreased, which decreases the dimension of the strips 124a along the Y axis. Since the natural frequency of a chord varies inversely with its length, the natural frequency of the strips 124a is increased.

On the other hand, decreasing the dimension of the bridge regions 22 along the Y axis causes the dimension of the slit region 21 along the Y axis to be increased, which increases the dimension of the strips 124a along the Y axis. As a result, the natural frequency of the strips 124a is decreased.

As described, adjusting the ratio between areas that the slit region 21 and bridge regions 22 occupy in the aperture region 20 allows the natural frequency of the strips 124a in the slit region 21 to be adjusted. This can cause the mask frame 12 and strips 124a to have different natural frequencies without adjusting tension applied to the strips 124a. As a result, vibrations of the color selection mask 11 due to resonance of the mask frame 12 and strips 124a can be controlled.

Further, the bridge regions 22 functioning as slot-type masks are provided at the both ends of the aperture region 20 along the Y axis, which prevents degradation of image quality at the both ends of the screen of the color cathode ray tube 1 along the Y axis.

The use of such mask assembly 10 in the color cathode ray tube 1 can provide users with high quality images.

Furthermore, if adjacent two of the slits 123 have different lengths along the Y axis, stresses applied near the adjacent two of the slits 123 are different from each other when the color selection mask 11 is tensed. Thus, a force deforming the slits 123 along the X axis is relatively likely to occur. In the present embodiment, however, adjacent two of the slits 123 have the same length along the Y axis, which can reduce a force exerted on the slits 123 along the X axis.

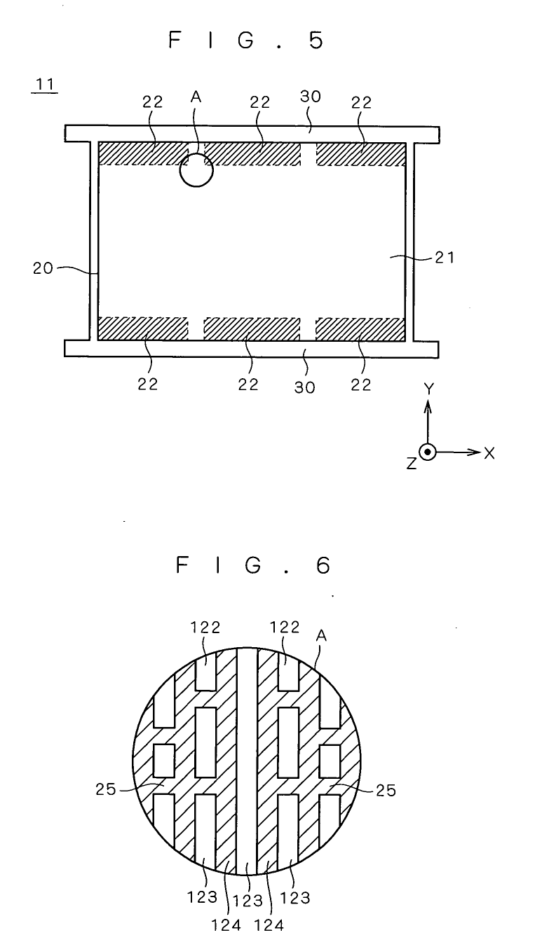

Although the bridge regions 22 of the present embodiment each extend from one end to the other end of the aperture region 20 along the X axis, the bridge regions 22 may be divided by the slit region 21 as shown in FIGS. 5 and 6 such that at least one of the slits 123 that reaches the bonding regions 30 is interposed between the divided bridge regions 22. In other words, a plurality of bridge regions 22 aligned in the X axis may be provided at the both ends of the aperture region 20 along the Y axis such that at least one of the slits 123 is interposed between adjacent two of the plurality of bridge regions 22. FIG. 6 is an enlarged view of a portion indicated by A of FIG. 5.

As described, interposing at least one of the slits 123 lying between adjacent two of the bridge regions 22 allows the occurrence of doming effect in the bridge regions 22 to be controlled as compared to the color selection mask 11 shown in FIG. 3. In this case, however, the force exerted on the slits 123 along the X axis can also be reduced in a portion where the slits 123 have the same length in the slit region 21.

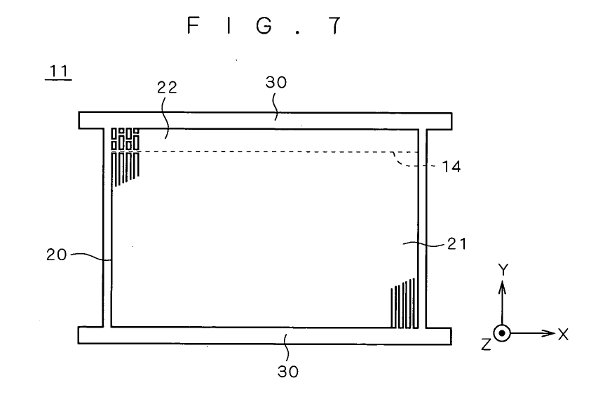

Although the bridge regions 22 are provided at the both ends of the aperture region 20 along the Y axis in the present embodiment, a bridge region 22 may be provided at either end of the aperture region 20 along the Y axis as shown in FIG. 7. In this case, the slit region 21 extends to reach the other end where the bridge region 22 is not provided.

Although the number of the damper line 13b is only one in the present embodiment, a plurality of pairs of damper springs 13a may be provided such that a plurality of damper lines 13b are provided.

Although the vibration damper 13 having the damper line 13b is employed in the present embodiment, the vibration damper disclosed in Document 2 or 3 may be adopted instead of the vibration damper 13.

### Second Preferred Embodiment

FIG. 8 is a plan view illustrating a color selection mask 51 according to a second preferred embodiment of the present invention. In the color selection mask 51 of the present embodiment, the configuration of bridges 25 between the slits 123 and those of the through holes 122 lying adjacent to the slits 123 along the Y axis are different from the color selection mask 11 according to the first preferred embodiment, which causes adjacent two of the slits 123 to have different lengths from each other.

As shown in FIG. 8, those of the bridges 25 lying between the slits 123 and those of the through holes 122 lying adjacent to the slits 123 are arranged in a staggered manner along the X axis in the bridge regions 22. As a result, the bridges 25 are arranged in a staggered manner in the whole bridge regions 22. Further, the configuration of the bridges 25 is symmetric about the central axis of the color selection mask 51 in the direction in which the Y axis extends in one of the bridge regions 22 on the top end of the color selection mask 51 and in the other one of the bridge regions 22 on the bottom end of the color selection mask 51.

With such arrangement of the bridges 25 in the bridge regions 22, a slit 123 having a length x along the Y axis and a slit 123 having a length y along the Y axis which is shorter than the length x are arranged alternately in the slit region 21. Further, with such arrangement of the bridges 25, the border 14 between the slit region 21 and each of the bridge regions 22 is of a waveform which is bent with intervals at which the slits 123 are aligned. The rest of the structure is the same as the color selection mask 11 according to the first preferred embodiment, explanation of which is thus omitted here.

As described, in the color selection mask 51 according to the present embodiment, adjacent two of the slits 123 have different lengths from each other, so that adjacent two of the strip 124a in the slit region 21 have different shapes from each other. Therefore, applying the color selection mask 51 according to the present embodiment to the mask assembly 10 instead of the color selection mask 11 allows adjacent two of the strips 124a to vibrate in different ways from each other. In FIG. 8, the strips 124a in the slit region 21 are indicated by slanted lines drawn upward to the left.

In the case where adjacent two of the strips 124a vibrate in the same way, the strips 124a are likely to resonate with each other. In the present embodiment, however, adjacent two of the strips 124a are caused to vibrate in different ways from each other, which can control the occurrence of resonance of the strips 124a.

Further, when applying a vibration damper provided in contact with a color selection mask such as the vibration damper 13 shown in FIG. 2 and the vibration damper disclosed in Document 2 or 3 to the mask assembly 10, such vibration damper may cause resonance of the strips 124a provided that adjacent two of the strips 124a vibrate in the same way. For instance, in the vibration damper 13, vibrations are in some cases transmitted through the damper line 13b to cause resonance of adjacent two of the strips 124a.

In the present embodiment, adjacent two of the strips 124a vibrate in different ways from each other, which can control the occurrence of resonance of the strips 124a due to a vibration damper provided in contact with a color selection mask.

Although the slits 123 are alternately long and short in the first preferred embodiment, some of the slits 123 in the slit region 21 may be monotonously increased or decreased in length along the Y axis.

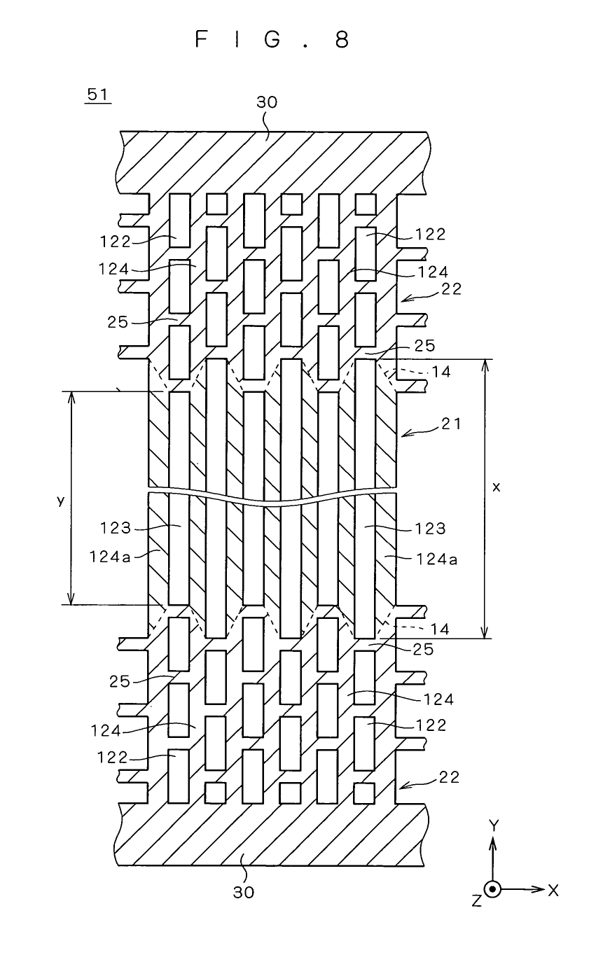

For instance, as shown in FIGS. 9 and 10, the bridges 25 between the slits 123 and those of the through holes 122 lying adjacent to the slits 123 along the Y axis may be arranged in line with a curve 80 extending along the X axis such that the border 14 between the slit region 21 and each of the bridge regions 22 draws a substantially curve over its entire length, thereby causing some of the slits 123 in the slit region 21 to monotonously vary in length. FIG. 10 is an enlarged view of a portion indicated by B of FIG. 9.

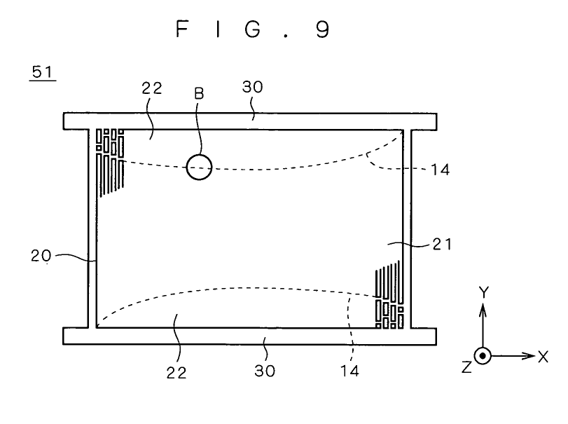

Alternatively, as shown in FIGS. 11 and 12, the bridges 25 between the slits 123 and those of the through holes 122 lying adjacent to the slits 123 along the Y axis may be arranged in line with a triangular waveform 81 extending along the X axis such that the border 14 between the slit region 21 and each of the bridge regions 22 draws a substantially triangular waveform over its entire length, thereby causing some of the slits 123 in the slit region 21 to monotonously vary in length. FIG. 12 is an enlarged view of a portion indicated by C of FIG. 11.

As described, causing some of the slits 123 in the slit region 21 to monotonously vary in length causes adjacent two of the strips 124a to have different lengths from each other. As a result, adjacent two of the slits 123 become different in shape and natural frequency, which can further control the occurrence of resonance of the strips 124a.

Further, the slits 123 gradually vary in length, so that a force exerted on the slits 123 along the X axis when mounting the color selection mask 51 is supported by the mask frame 12 under tension can be reduced.

In this case, and when the mask assembly 10 has a vibration damper provided in contact with a color selection mask, the occurrence of resonance of the strips 124a due to such vibration damper can further be controlled.

Document 1 also discloses a technique of varying adjacent two strips in length for controlling resonance of the strips due to a damper line. In this case, however, the difference in length of the strips are visually recognized as irregularities on the screen of a cathode ray tube, resulting in a problem in that images are not displayed properly at the ends of the screen in the vertical direction.

On the other hand, in the present embodiment, the bridge regions 22 functioning as slot-type masks are provided at the ends of the aperture region 20 along the Y axis, allowing an image to be properly displayed at the ends of the screen in the vertical direction.

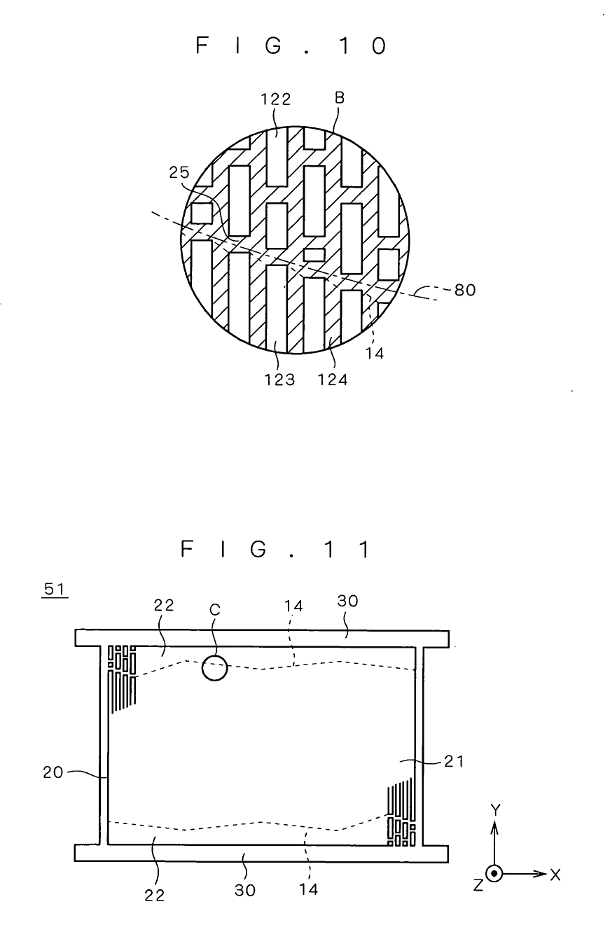

Further, although the bridge regions 22 each extend from one end to the other end of the aperture region 20 along the X axis in the present embodiment, the bridge regions 22 may each be divided by the slit region 21 such that at least one of the slits 123 that reaches the bonding regions 30 is interposed between the divided bridge regions 22. For instance, as shown in FIG. 13, some of the slits 123 in the slit region 21 vary monotonously in length along the Y axis while at least one of the slits 123 is interposed between the divided bridge regions 22, thereby controlling the occurrence of resonance of the strips 124a while controlling the occurrence of doming effect in the bridge regions 22.

### Third Preferred Embodiment

In the aforementioned first and second preferred embodiments, a phenomenon may occur in which adjacent two of the strips 124a come into contact with each other due to vibrations and produce friction therebetween to get entangled with each other without recovering to their original positions while overlapping each other (hereinafter called “grille entanglement”).

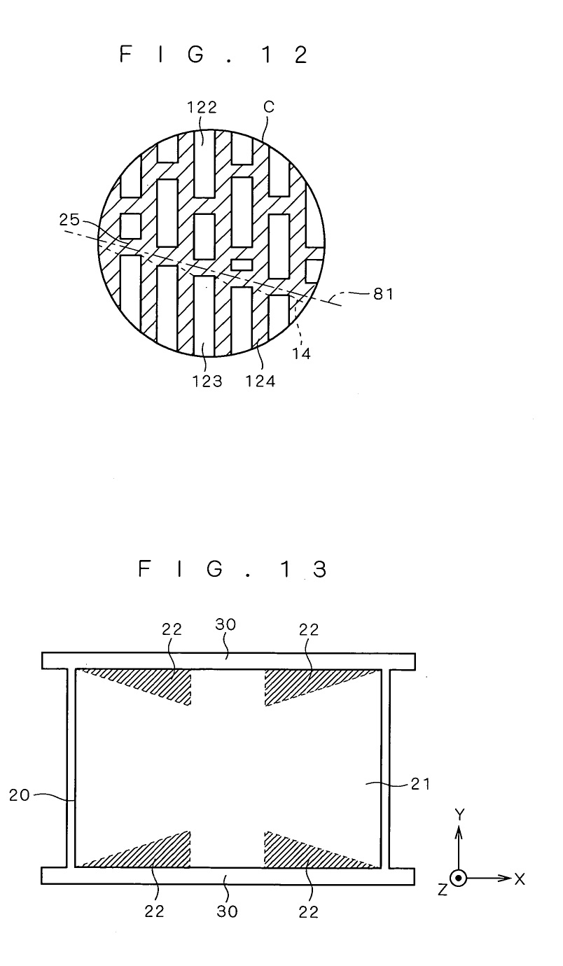

FIGS. 14A and 14B illustrate the manner in which the strips 124a come into contact with each other. FIG. 14A illustrates the state before the strips 124a come into contact, and FIG. 14B illustrates the state after coming into contact.

As shown in FIG. 14A, when vibrations of a color selection mask causes a force indicated by arrows to be exerted on adjacent two of the strips 124a, the two strips 124a come into line contact with each other as shown in FIG. 14B. This may produce great friction between the strips 124a, resulting in grille entanglement.

Therefore, the third preferred embodiment is directed to provide the strips 124a in the slit region 21 with projections projecting along the X axis to reduce friction between the strips 124a when the strips 124a come into contact with each other, thereby controlling the occurrence of grill entanglement. This will specifically be described below.

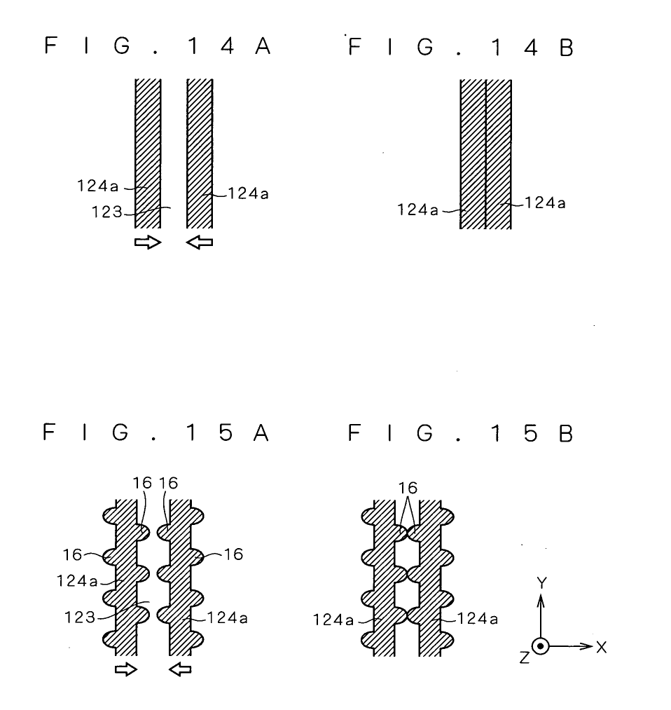

FIGS. 15A and 15B illustrate the configuration of the strips 124a in the slit region 21 according to the present embodiment. FIG. 15A illustrates the state before the strips 124a come into contact, and FIG. 15B illustrates the state after coming into contact.

As shown in FIGS. 15A and 15B, projections 16 projecting along the X axis but not connecting adjacent two of the strips 124a are provided on the both edges of the strips 124a along the X axis. In the present embodiment, those of the projections 16 provided on the respective edges of adjacent two of the strips 124a that face each other are in the same position along the Y axis and face each other. The projections 16 each have an arched end, for example.

As described, providing the projections 16 at least for the strips 124a in the slit region 21 causes the strips 124a to come into point contact with each other as shown in FIG. 15B when a force indicated by arrows shown in FIG. 15A is applied to the strips 124a. This reduces contact area between the strips 124a, which reduces friction therebetween. As a result, the occurrence of grille entanglement can be controlled.

The projections 16 may not necessarily be provided on the both edges of each of the strips 124a, but may be provided only on one side edge of each of the strips 124a along the X axis. In this case, in adjacent two of the strips 124a, the projections 16 are provided on the same side edges.

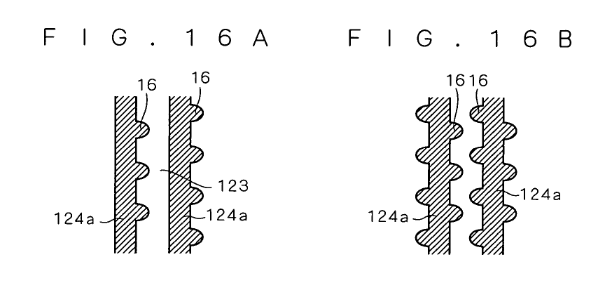

When providing the projections 16 on the both edges of each of the strips 124a, those of the projections 16 provided on the respective edges of adjacent two of the strips 124a that face each other may be in different positions along the Y axis, as shown in FIG. 16B.

Further, although having an arched end in the present embodiment, the projections 16 may each have an end of different shapes than arc since they only need to reduce contact area between adjacent two of the strips 124a.

While the invention has been shown and described in detail, the foregoing description is in all aspects illustrative and not restrictive. It is therefore understood that numerous modifications and variations can be devised without departing from the scope of the invention.

What is claimed is:

1. A mask assembly comprising:
a color selection mask including an aperture region provided with a plurality of holes through which electron beams pass; and
a mask frame for supporting said color selection mask and applying tension to said color selection mask in a first direction, wherein
said aperture region has a bridge region at an end thereof in said first direction and a slit region adjacent to said bridge region at least in said first direction,
said slit region has a plurality of strips, each extending in said first direction, arranged at a predetermined pitch in a second direction perpendicular to said first direction and a plurality of slits, each being defined between adjacent two of said plurality of strips, and
said bridge region, into which said plurality of strips extend, has bridges for connecting adjacent two of said plurality of strips.

2. The mask assembly according to claim 1, wherein
said aperture region has a plurality of bridge regions aligned in said second direction, and
at least one of said plurality of slits is interposed between adjacent two of said plurality of bridge regions.

3. The mask assembly according to claim 1, wherein
adjacent two of said plurality of slits in at least part of said slit region have the same length in said first direction.

4. The mask assembly according to claim 1, wherein
adjacent two of said plurality of slits in at least part of said slit region have different lengths from each other in said first direction.

5. The mask assembly according to claim 4, wherein
said plurality of slits in said slit region include a first slit having a first length and a second slit having a second length shorter than said first length, said first slit and second slit are arranged alternately.

6. The mask assembly according to claim 4, wherein
said plurality of slits in said slit region monotonously vary in length in said first direction.

7. The mask assembly according to claim 4, further comprising
a vibration damper provided in contact with said color selection mask.

8. The mask assembly according to claim 7, wherein
said vibration damper includes a damper line extending in said second direction to which tension is applied in said second direction, said damper line being in contact with some of said plurality of strips in said at least part of said slit region.

9. The mask assembly according to claim 1, wherein
said plurality of strips in said slit region have projections projecting in said second direction.

10. A cathode ray tube comprising:
an electron gun; and
a mask assembly for selecting electron beams emitted from said electron gun, wherein
said mask assembly includes:
a color selection mask having an aperture region provided with a plurality of holes through which said electron beams pass; and
a mask frame for supporting said color selection mask and applying tension to said color selection mask in a first direction,
said aperture region has a bridge region at an end thereof in said first direction and a slit region adjacent to said bridge region at least in said first direction,
said slit region has a plurality of strips, each extending in said first direction, arranged at a predetermined pitch in a second direction perpendicular to said first direction and a plurality of slits, each being defined between adjacent two of said plurality of strips, and
said bridge region, into which said plurality of strips extend, has bridges for connecting adjacent two of said plurality of strips.
